(19) United States
(12) Patent Application Publication
(10) Pub. No.: US 2013/0276642 A1
(43) Pub. Date: Oct. 24, 2013

(54) Personal Cake Pan

(71) Applicant: Margarite Remsey, Little Falls, NJ (US)

(72) Inventor: Margarite Remsey, Little Falls, NJ (US)

(21) Appl. No.: 13/851,065

(22) Filed: Mar. 26, 2013

Related U.S. Application Data
(60) Provisional application No. 61/685,878, filed on Mar. 26, 2012.

(51) Int. Cl. A21B 3/13

(52) U.S. Cl. CPC A21B 3/13
USPC 99/426

(57) ABSTRACT

The invention provides a specially designed cake pan comprising six individual cooking molds, inside of which small, uniform and single serving size cakes are baked. The Personal Cake Pan provides household consumers and professional bakers with a simple means of preparing individual cakes for guests attending parties and other celebrations, providing a stylish and cost effective alternative to baking a single large cake.

### CLAIM OF PRIORITY

This patent application claims priority under 35 USC 119 (e) (1) from U.S. Provisional Patent Application Ser. No. 61/685,878 filed Mar. 26, 2012, of common inventorship herewith entitled, “Personal Cake Pan.”

### FIELD OF THE INVENTION

The present invention pertains to the field of kitchen accessories, and more specifically to the field of oven baking pans.

### BACKGROUND OF THE INVENTION

The prior art has put forth several designs for oven baking pans. Among these are:

U.S. Pat. No. 3,831,507 to Donald S. Wheaton describes a baking pan assembly and a method of using same to make a sandwich bun having separate upper and lower portions. Three baking pans are arranged in a vertical substantially sealed relationship. The middle pan in this assembly has a unique shape which forms a bowl like recess in a lower portion of the bun. This design contributes in the baking process to permit the lower surface of the top portion of the bun and the interior surface defining the recess in the lower portion of the bun to bake fully in a soft and unbrowned condition.

U.S. Pat. No. 6,869,059 to William E. Sloan and Matthew W. Lorence describes a pan for baking a batter or dough to provide baked goods such as muffins or cupcakes. The pan includes a raised perimeter wall that acts as a shield or baffle to provide consistent air flow over the batter or dough during baking. The resulting baked goods have improved baked properties.

U.S. Pat. No. 7,150,221 to Fletcher Morgan describes an assembly for forming multiple individual compound desserts in a predetermined dome shape including a base tray having a plurality of recessed cavities to form a base for said compound dessert. A rack and a plurality of dome shaped bowl assemblies are secured in a fixed position to said rack. Each bowl assembly is formed with a closed semispherical end and an open end forming a cavity, and a cover member which is mounted over said open end. The cover member has an inner bowl that extends into the cavity.

None of these prior art references describe the present invention.

### SUMMARY OF THE INVENTION

It is an object of the present invention to provide a cake pan with six molds for baking small individual serving size cakes.

### BRIEF DESCRIPTION OF THE DRAWINGS

FIG. 1 is a prototypical diagonal top view showing six cake molds and gripping handles.

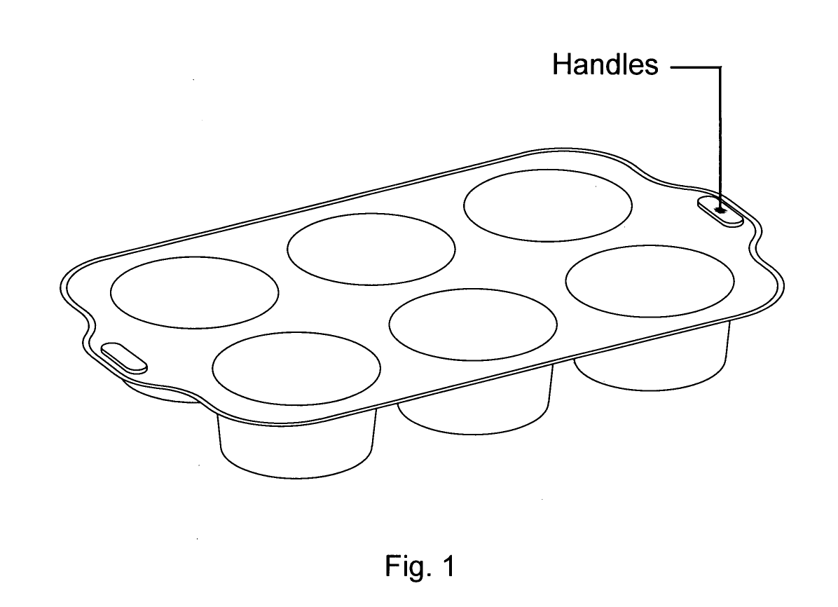

### DETAILED DESCRIPTION OF THE INVENTION

Cake is a universal symbol of celebration. Whether it is a birthday party, a retirement function, an anniversary soiree or a wedding reception, these occasions are incomplete without a frosted tower of sugar and flour to add sweet merriment to the festivities. Cakes as desserts are synonymous with birthday and special occasion celebrations. A cake is the centerpiece for any wedding or anniversary celebration, providing dessert and a decorative focal point for party guests to celebrate. Christmas celebrations are accentuated with delights such as red velvet cake, rum cake, chocolate cakes and traditional fruitcakes. Cake is a comfort food to be enjoyed any time, from a scrumptious slice of pineapple upside down cake as an after school snack to a thick moist wedge or chocolate fudge cake with coffee after a meal. The versatile cake confection is perfect satiation for virtually anyone's sweet tooth.

When preparing a cake, the finished batter is poured into a circular, square, rectangular or Bundt shaped cake pan. The pan is placed in the oven and the cake is cooked until firm yet springy. The warm cake is removed from the oven and allowed to cool before it is carefully frosted and decorated. Prior to frosting, the cake pan typically is inverted to remove the cake from the pan. The cake is placed on a cake dish or similar serving receptacle so the baker can frost and decorate the top and sides of the cake. One drawback associated with cake has to do with cutting and serving the delicious dessert treat. Cutting equally sized portions when slicing a cake is a challenge especially if the cake is tiered or oddly shaped. Some party revelers may end up with too much cake on their plates while others may have a piece of cake too small to properly satisfy their sweet tooth. If too much cake is left after the event, the leftover cake often ends up drying out or being discarded.

The present invention, hereinafter referred to as the Personal Cake Pan, is a specially designed cake pan comprising six individual cooking molds, inside of which small, uniform and single serving size cakes are baked. The Personal Cake Pan provides household consumers and professional bakers with a simple means of preparing individual cakes for guests attending parties and other celebrations, providing a stylish and cost effective alternative to baking a single large cake. The Personal Cake Pan is available in a variety of materials including heavy duty aluminum, Teflon or enamel coated steel, silicone or ceramic. A standard embodiment of the Personal Cake Pan is a rectangular shaped unit measuring approximately seventeen and a half inches in length and ten inches in width that easily accommodates a standard thirty inch oven. As opposed to being a solid receptacle inside of which a single cake is baked, the Personal Cake Pan comprises a series of individual cake molds, enabling a user to prepare several perfectly sized miniature cakes at once. The standard embodiment of the Personal Cake Pan comprises six evenly spaced molds that are configured in two rows of three molds each. Circular in shape, these individual molds measure approximately four and six tenths inches in diameter, and one and one half to two and one half inches in depth. Larger embodiments of the Personal Cake Pan are available for professional use and comprise a dozen or more cake molds per pan.

Use of the Personal Cake Pan is very simple and straight forward. A user purchases one or more Personal Cake Pans to accommodate their party needs. A hostess throwing a birthday party for a teen and ten friends may purchase two pans. A homemaker may purchase a single Personal Cake Pan for general dessert use. After preparing a favorite cake batter, a user pours the batter into the Personal Cake Pan's individual cake molds, making sure the batter in each mold is even and level with the batter in the next mold. The user places the Personal Cake Pan in the oven and cooks the cakes according to recipe instructions. When the individual cakes have been properly cooked, the user removes the Personal Cake Pan from the oven and allows the cakes to cool. The user removes the cakes from their individual molds, and then frosts and decorates each cake as desired. The individual cakes are served to party guests or family members providing a delectable and perfectly portioned treat.

The Personal Cake Pan provides a new and exciting alternative to serving a single full sized cake. All guests or family members have their own perfectly sized and shaped cake, eliminating issues associated with attempting to cut a cake into a uniform piece for each guests. Party hostesses are spared cutting a birthday or holiday cake, only to realize that they have cut slices too big or too small. Consumers produce a variety of cake offerings for their guests or family members while using the same pan. A baker may fill half the cake molds with chocolate cake batter and the other half with vanilla cake batter. A baker decorates individual cakes using the same pattern or a baker creates a number of exciting cake designs to accommodate individual party guests or various components of a celebratory theme. Providing a striking decorative element to any party decor, the Personal Cake Pan enables a hostess to make any birthday, anniversary or holiday celebration extra special. The Personal Cake Pan is a practical product invention that provides a fun and unique means of serving cake. Simple to use, this handy cake pan is an invaluable kitchen accessory. Affordably priced and durably constructed, the Personal Cake Pan will withstand years of use in both household and professional kitchens.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cake pan with six molds for baking small individual serving size cakes, comprising: a cake pan comprising six individual cooking molds.

2. The cake pan of claim 1 made of heavy duty aluminum, Teflon™ or enamel coated steel, silicone or ceramic.

3. The cake pan of claim 1 wherein the cake pan is a rectangular shaped unit measuring approximately seventeen and a half inches in length and ten inches in width.

4. The cake pan of claim 1 wherein the molds are evenly spaced molds that are configured in two rows of three molds each.

5. The cake pan of claim 1 wherein the molds are circular in shape, and measure approximately four and six tenths inches in diameter, and one and one half to two and one half inches in depth.
